(19) United States
(12) Patent Application Publication
(10) Pub. No.: US 2015/0047019 A1
(43) Pub. Date: Feb. 12, 2015

(54) INFORMATION PROCESSING METHOD AND ELECTRONIC DEVICE

(71) Applicant: LENOVO (BEIJING) LIMITED, Beijing (CN)

(72) Inventor: Qiang Dong, Beijing (CN)

(73) Assignee: LENOVO (BEIJING) LIMITED, Beijing (CN)

(21) Appl. No.: 14/227,887

(22) Filed: Mar. 27, 2014

(30) Foreign Application Priority Data
Aug. 12, 2013 (CN) 201310349795.2

(51) Int. Cl. G06F 21/32

(52) U.S. Cl. CPC G06F 21/32; G06F 2221/2141
USPC 726/19

(57) ABSTRACT

The present disclosure provides an information processing method and an electronic device. The method comprises: determining, when a first application starts, whether first authentication data obtained by the electronic device at time T1 satisfies a predetermined condition, so as to obtain a first determination result, where the time T1 is prior to the starting of the first application; presenting an application interface for the first application by using a first display strategy, if the first determination result indicates that the first authentication data obtained by the electronic device at time T1 satisfies the predetermined condition; and presenting an application interface for the first application by using a second display strategy different from the first display strategy, if the first determination result indicates that the first authentication data obtained by the electronic device at time T1 does not satisfy the predetermined condition.

### TECHNICAL FIELD

The present invention relates to electronic technology, and more particularly, to an information processing method and an electronic device.

### BACKGROUND

With the continuous development of science and technology, electronic devices have been developing rapidly. There are more and more types of electronic products and people are enjoying various convenience brought by technical development. Now, with various electronic devices, people can enjoy comfortable lives brought by technical development. For example, existing electronic devices have a function of setting passwords. Users can encrypt the desired files, applications, and received private information such that they can be only opened by the users knowing the passwords (such as passwords or images for unlocking mobile phones and encryption information sent by a sender).

During the implementation of the solutions according to the embodiments of the present application, the inventors found at least the following problem. Conventionally, passwords are set for encrypting contents to be protected by users. When the users need to access these contents, they can be displayed to the user properly if password verification passes. If the password verification does not pass, the users are prompted that the input password is incorrect or the password is null. However, it gives hint to illegal users and thus security of information is reduced.

### SUMMARY

The embodiments of the present invention provide an information processing method and an electronic device, capable of solving the technical problem that when a password input by an illegal user upon starting an application does not satisfies a predetermined condition, an electronic device will prompt the user that the input password is incorrect and thus security of information is reduced.

According to an embodiment of the present invention, an information processing method is provided. The method is used in an electronic device. The method comprises: determining, when a first application starts, whether first authentication data obtained by the electronic device at time T1 satisfies a predetermined condition, so as to obtain a first determination result, where the time T1 is prior to the starting of the first application; presenting an application interface for the first application by using a first display strategy, if the first determination result indicates that the first authentication data obtained by the electronic device at time T1 satisfies the predetermined condition; and presenting an application interface for the first application by using a second display strategy different from the first display strategy, if the first determination result indicates that the first authentication data obtained by the electronic device at time T1 does not satisfy the predetermined condition.

Preferably, the time T1 is a time at which the electronic device collects first authentication data for a user of the electronic device by means of a collecting unit.

Preferably, the time T1 is a time at which the electronic device switches from a screen-locked state to a screen-unlocked state.

Preferably, the time T1 is a time at which the electronic device obtains a first operation for starting the first application.

Preferably, said determining whether first authentication data obtained by the electronic device at time T1 satisfies a predetermined condition comprises: determining whether the first authentication data obtained by the electronic device at the time T1 is null; or determining whether the first authentication data matches preset authentication data or not, if the obtained first authentication data is not null.

Preferably, said presenting an application interface for the first application by using a first display strategy if the first determination result indicates that the first authentication data obtained by the electronic device at time T1 satisfies the predetermined condition comprises: presenting an application interface for the first application by using a first display strategy, if the first determination result indicates that the first authentication data obtained by the electronic device at time T1 is not null and the first authentication data matches the preset authentication data.

Preferably, said presenting an application interface for the first application by using a second display strategy different from the first display strategy if the first determination result indicates that the first authentication data obtained by the electronic device at time T1 does not satisfy the predetermined condition comprises: presenting an application interface for the first application by using a second display strategy different from the first display strategy, if the first determination result indicates that the first authentication data obtained by the electronic device at time T1 is null or if the first determination result indicates that the first authentication data obtained by the electronic device at time T1 is not null and the first authentication data does not match the preset authentication data.

Preferably, the first authentication data comprises fingerprint data, face image data, or iris data.

According to another embodiment of the present invention, an electronic device is provided. The electronic device comprises: a determining module configured to determine, when a first application starts, whether first authentication data obtained by the electronic device at time T1 satisfies a predetermined condition, so as to obtain a first determination result, where the time T1 is prior to the starting of the first application; a first presenting module configured to present an application interface for the first application by using a first display strategy, if the first determination result indicates that the first authentication data obtained by the electronic device at time T1 satisfies the predetermined condition; and a second presenting module configured to present an application interface for the first application by using a second display strategy different from the first display strategy, if the first determination result indicates that the first authentication data obtained by the electronic device at time T1 does not satisfy the predetermined condition.

Preferably, the determining module is further configured to: determine whether the first authentication data obtained by the electronic device at the time T1 is null; or determine whether the first authentication data matches preset authentication data or not, if the obtained first authentication data is not null.

Preferably, the first presenting module is further configured to: present an application interface for the first application by using a first display strategy, if the first determination result indicates that the first authentication data obtained by the electronic device at time T1 is not null and the first authentication data matches the preset authentication data.

Preferably, the second presenting module is further configured to: present an application interface for the first application by using a second display strategy different from the first display strategy, if the first determination result indicates that the first authentication data obtained by the electronic device at time T1 is null or if the first determination result indicates that the first authentication data obtained by the electronic device at time T1 is not null and the first authentication data does not match the preset authentication data.

One or more of the above solutions according to the embodiments of the present application have at least the following technical effects or advantages.

1) According to the present invention, an application interface for the first application is presented by using a first display strategy if the obtained first authentication data satisfies the predetermined condition and an application interface for the first application is presented by using a second display strategy different from the first display strategy if the obtained first authentication data does not satisfy the predetermined condition. Thus, if the predetermined condition is not satisfied, the displaying is performed by using the second display strategy. The present invention solves the technical problem that the same interface will be displayed if a predetermined condition is not satisfied (for example, a user input is error or null). Moreover, the present invention has an advantage that security of user information is improved.

2) In the present invention, whether first authentication data for a user satisfies a predetermined condition is verified in three scenarios, i.e. when it is to collect first authentication data for a user of the electronic device by means of a collecting unit, when it is to switch the electronic device from a screen-locked state to a screen-unlocked state, and when it is to obtain a first operation for starting the first application. Therefore, the present invention efficiently solves the technical problem that password verification is only performed when the electronic device starts and security cannot be assured when application and contents of the electronic device are used by other illegal users after the electronic device has started. Furthermore, a user can unlock the electronic device conveniently while security of the user information can be assured.

### BRIEF DESCRIPTION OF THE DRAWINGS

FIG. 1 is a flowchart illustrating an information processing method according to an embodiment of the present application;

FIG. 2 is a diagram showing content on the screen when a predetermined condition is not satisfied according to an embodiment of the present application;

FIG. 3 is a diagram showing content on the screen when a predetermined condition is satisfied according to an embodiment of the present application;

FIG. 4 is a schematic diagram showing specific steps in an information processing method according to an embodiment of the present application; and

FIG. 5 is a block diagram showing an electronic device according to an embodiment of the present application.

### DETAILED DESCRIPTION OF THE EMBODIMENTS

The embodiments of the present invention provide an information processing method and an electronic device, capable of solving the technical problem that security of user information is reduced due to an electronic device prompts that a password input by an illegal user is incorrect when the user tries to start an application by inputting the password and the password does not satisfy a predetermined condition.

In order to solve the above problem, the general concept of the solutions according to the embodiments of the present invention is as follows.

For example, in an intelligent mobile phone, when a user receives a private short message from a sender via the intelligent mobile phone, a touch operation by the user is obtained before the user opens the private short message. Therefore, during a touch operation of the private short message by the user, the electronic device obtains first authentication data. Then, it is determined whether the first authentication data satisfies a predetermined condition. If the first authentication data satisfies the predetermined condition, content of the private short message will be presented by using a first display strategy, i.e. the content of the private short message will be presented normally. If the first authentication data does not satisfy the predetermined condition, content of the private short message will be presented by using a second display strategy, i.e. the content of the private short message will be presented abnormally (such as garbled codes). As a result, if the obtained first authentication data does not satisfy the predetermined condition, only abnormal content is displayed and no prompt is provided to the user. Accordingly, security of user information can be assured when an illegal user operates the mobile phone.

To make better understanding of the above solutions, the solutions of the present invention will be described in detail with reference to the figures and the embodiments below.

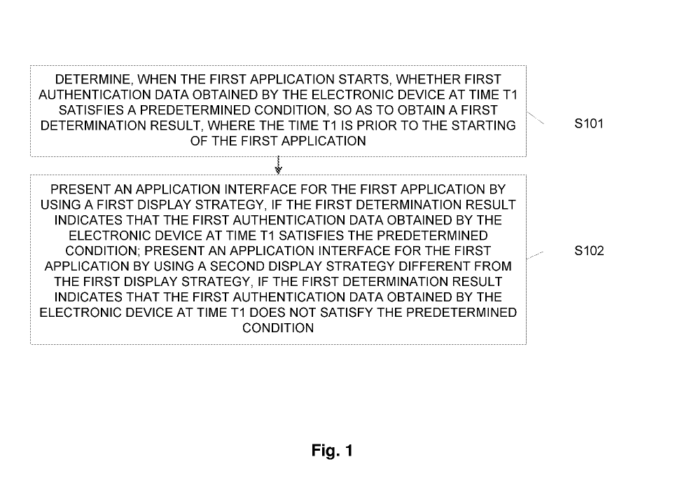

According to an embodiment of the present invention, an information processing method for use in an electronic device is provided. As shown in FIG. 1, the method comprises the following steps:

Step S101: it is determined, when a first application starts, whether first authentication data obtained by the electronic device at time T1 satisfies a predetermined condition, so as to obtain a first determination result, where the time T1 is prior to the starting of the first application.

Step S102: an application interface for the first application is presented by using a first display strategy, if the first determination result indicates that the first authentication data obtained by the electronic device at time T1 satisfies the predetermined condition. In addition, an application interface for the first application is presented by using a second display strategy different from the first display strategy, if the first determination result indicates that the first authentication data obtained by the electronic device at time T1 does not satisfy the predetermined condition.

In step S101, the time T1 may be one of the following:

(1) a time at which the electronic device collects a first authentication data for a user of the electronic device by means of a collecting unit.

(2) a time at which the electronic device switches from a screen-locked state to a screen-unlocked state.

(3) a time at which the electronic device obtains a first operation for starting the first application.

In the next, processes of presenting content to a user in the above three scenarios will be described in detail.

First, in the first scenario, when it is to collect first authentication data by means of a collecting unit, it is determined whether the obtained first authentication data satisfies a predetermined condition. Here, the first authentication data may comprise fingerprint data, face image data, or iris data. Accordingly, the collecting unit may comprise a fingerprint collecting unit, an image collecting unit, or an iris collecting unit.

After obtaining the first authentication data at time T1, it is determined whether the obtained first authentication data satisfies a predetermined condition. In particular, it is determined whether the first authentication data obtained by the electronic device at the time T1 is null. Alternatively, it is determined whether the first authentication data matches preset authentication data or not if the obtained first authentication data is not null.

In an embodiment, fingerprint information of a user is collected at time T1 by means of a fingerprint collecting unit, for example. Prior to using applications on an intelligent mobile phone, a user performs a touch operation on the intelligent mobile phone by means of fingers. During operations of the intelligent mobile phone by the user, a fingerprint collecting unit is therefore started and obtains fingerprint data for the user. Then, in the process of determining whether the fingerprint data satisfies the predetermined condition, the fingerprint data for the user obtained may be one of the following situations.

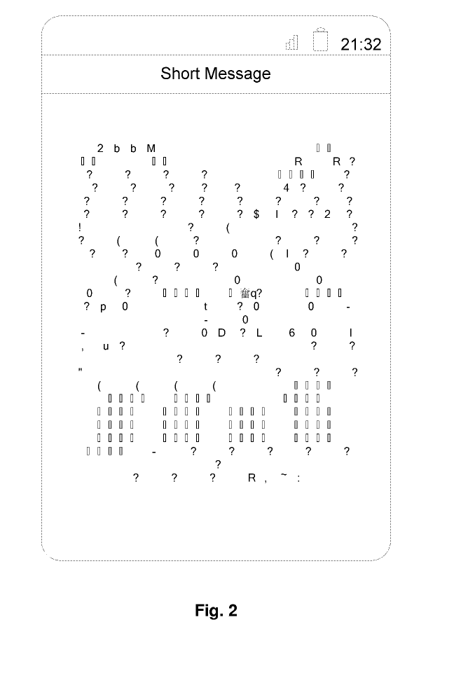

First, the obtained fingerprint data is null. That is, even if a touch operation of the intelligent mobile phone by the user is detected, the fingerprint collecting unit does not obtain fingerprint data for the user. In this situation, a first determination result indicates that the fingerprint data obtained by the electronic device at the time T1 does not satisfy the predetermined condition. Thus, an interface for an application is presented by using a first display strategy. For example, the user may want to read a short message. Because the intelligent mobile phone obtains no fingerprint data for the user, it presents content of the short message to the user in garbled codes, as shown in FIG. 2. Of course, the present invention is not limited to presenting content of a short message. For example, it applies to the cases where content of a mail or an instant message is to be presented, and the like.

Second, the obtained fingerprint data is not null but does not match the preset fingerprint data. That is, the fingerprint data obtained at time T1 does not satisfy a predetermined condition. In this situation, an abnormal interface for an application to be started by the user is presented. As mentioned above, the user may want to read a short message. Because the obtained fingerprint data does not satisfy a predetermined condition, content of the short message is presented to the user in garbled codes, as shown in FIG. 2.

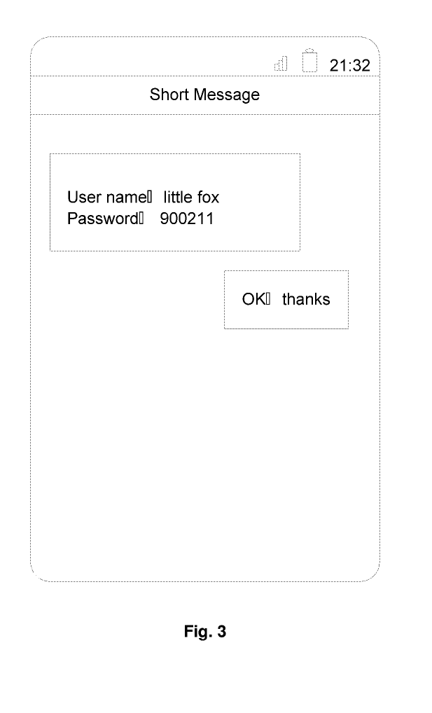

Third, the obtained fingerprint data is not null and matches the preset fingerprint data. That is, the fingerprint data obtained at time T1 satisfies a predetermined condition. In this situation, when the user reads a short message, content of the short is presented to the user normally, as shown in FIG. 3.

As discussed above, content of a short message can be presented in different strategies under different situations. Naturally, if an application is to be started, a failure interface for the application may be presented to a user if the obtained first authentication data does not satisfy a predetermined condition. Of course, the present invention is not limited thereto.

In the second situation, the time T1 is a time at which the electronic device switches from a screen-locked state to a screen-unlocked state.

In an embodiment, an electronic device itself can set a time out for screen-locked state. In particular, when a user is using a protected application (such as a micro-blog application), the electronic device may enter a screen-locked state automatically if no touch operation has been performed on the screen for a certain period. Then, the user needs to switch the electronic device from the screen-locked state to a screen-unlocked state. If another user (an illegal user) can unlock the electronic device, he/she can get into for example the interface for the micro-blog application for the previous user. Thus, security of information of the user of the electronic device cannot be guaranteed. Accordingly, during switching of states, it is determined whether the first authentication data satisfies a predetermined condition. For example, it is determined whether iris information for the user satisfies a predetermined condition. If it does not satisfy the predetermined condition, the electronic device presents a failure interface for the micro-blog application to the user. For example, only an icon for the micro-blog application is displayed in the failure interface and specific content of a home page of the micro-blog application's user is not displayed. If the electronic device is unlocked by the previous user, the electronic device can be unlocked directly if the predetermined condition is satisfied and presents the content of the home page browsed by the micro-blog application's user previously. On one hand, it is convenient for an authorized user to access a desired application interface. On the other hand, security of user information can be ensured. Of course, the specific application is not limited to a micro-blog application and instead can comprise other applications such as e-Wallet or screen being viewed, etc.

In the third situation, the time T1 is a time at which the electronic device obtains a first operation for starting the first application by a user.

Conventionally, it needs to determine whether a user has usage right when the user turns on an electronic device. After the determination, the user has usage rights of all applications on the electronic device, including rights to modify settings, etc. However, this cannot ensure security of information of the owner of the electronic device. If another user may start to use some applications on the same electronic device after the electronic device is turned on, he/she has the same usage right as the previous user. Therefore, in this situation, it is necessary to set authorities for respective applications on the electronic device. When a user who has an authority operates a corresponding application (such as using a browser application on the electronic device through sliding or clicking an icon), it is determined whether the operation of the user satisfies a predetermined condition. For example, a user may click an icon of the browser application. The electronic device checks fingerprint data obtained during the click operation, and presents a normal home page of the browser application only if the obtained fingerprint is not null and matches a preset fingerprint. If no fingerprint data is obtained or the obtained fingerprint does not match a preset fingerprint, the electronic device will present an abnormal interface for the browser application. For example, only an icon of the browser application is displayed and an access interface for search is not displayed.

In the embodiments of the present application, it is preferred that the time T1 is a time at which the electronic device obtains first authentication data for a user of the electronic device. In this situation, it is assured that the first authentication data for the user can be determined whenever the user obtains information for a corresponding application, and thus security of user information is guaranteed. In addition, security of user information can be further improved by displaying different determination results in different strategies such that an illegal user cannot know a particular determination result.

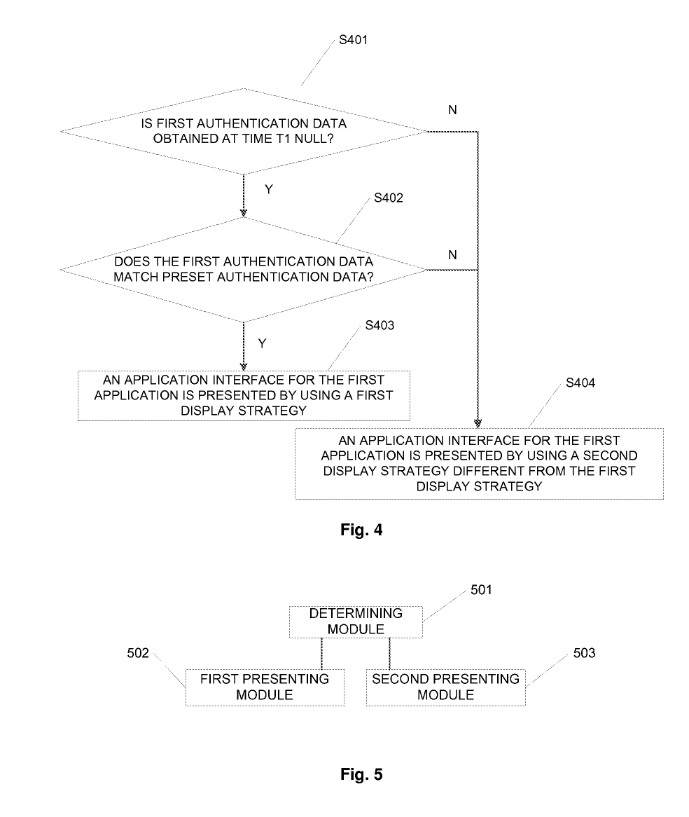

The process of the present application will be described in the following with reference to FIG. 4.

Step S401: when a first application starts, it is determined whether first authentication data obtained at time T1 is null. If it is not, step S402 is performed; otherwise, step S404 is performed.

Step S402: it is determined whether the first authentication data matches preset authentication data. If it is not, step S404 is performed; otherwise, step S403 is performed.

Step S403: an application interface for the first application is presented by using a first display strategy.

Step S404: an application interface for the first application is presented by using a second display strategy different from the first display strategy.

FIG. 5 is a block diagram showing an electronic device according to an embodiment of the present application. As shown in FIG. 5, the electronic device comprises the following components.

A determining module 501 is configured to determine, when a first application starts, whether first authentication data obtained by the electronic device at time T1 satisfies a predetermined condition, so as to obtain a first determination result, where the time T1 is prior to the starting of the first application.

A first presenting module 502 is configured to present an application interface for the first application by using a first display strategy, if the first determination result indicates that the first authentication data obtained by the electronic device at time T1 satisfies the predetermined condition.

A second presenting module 503 is configured to present an application interface for the first application by using a second display strategy different from the first display strategy, if the first determination result indicates that the first authentication data obtained by the electronic device at time T1 does not satisfy the predetermined condition.

Preferably, the determining module 501 is further configured to determine whether the first authentication data obtained by the electronic device at the time T1 is null, or determine whether the first authentication data matches preset authentication data or not if the obtained first authentication data is not null.

Preferably, the first presenting module 502 is further configured to present an application interface for the first application by using a first display strategy if the first determination result indicates that the first authentication data obtained by the electronic device at time T1 is not null and the first authentication data matches the preset authentication data.

Preferably, the second presenting module 503 is further configured to present an application interface for the first application by using a second display strategy different from the first display strategy if the first determination result indicates that the first authentication data obtained by the electronic device at time T1 is null or if the first determination result indicates that the first authentication data obtained by the electronic device at time T1 is not null and the first authentication data does not match the preset authentication data.

One or more of the above solutions according to the embodiments of the present application have at least the following technical effects or advantages.

1) According to the present invention, an application interface for the first application is presented by using a first display strategy if the obtained first authentication data satisfies the predetermined condition and an application interface for the first application is presented by using a second display strategy different from the first display strategy if the obtained first authentication data does not satisfy the predetermined condition. Thus, if the predetermined condition is not satisfied, the displaying is performed by using the second display strategy. The present invention solves the technical problem that the same interface will be displayed if a predetermined condition is not satisfied (for example, a user input is error or null). Moreover, the present invention has an advantage that security of user information is improved.

2) In the present invention, whether first authentication data for a user satisfies a predetermined condition is verified in three scenarios, i.e. when it is to collect first authentication data for a user of the electronic device by means of a collecting unit, when it is to switch the electronic device from a screen-locked state to a screen-unlocked state, and when it is to obtain a first operation for starting the first application. Therefore, the present invention efficiently solves the technical problem that password verification is only performed when the electronic device starts and security cannot be assured when application and contents of the electronic device are used by other illegal users after the electronic device has started. Furthermore, a user can unlock the electronic device conveniently while security of the user information can be assured.

Those skilled in the art will appreciate that the embodiments of the present invention can be provided as a method, a system or a computer program product. Therefore, the present invention can be implemented through hardware, software, or a combination thereof. Moreover, the present invention can be implemented as a computer program product embodied on a computer readable medium storing thereon computer readable codes, including but not limited to a magnetic disk, CD-ROM, optical storage, etc.

The principles of the present invention are described with reference to flowcharts or block diagrams of exemplary methods, devices (systems), and computer program products. It should be understood that each process/block in the flowcharts/block diagrams or a combination thereof can be implemented by computer program instructions. These computer program instructions can be provided to a general computer, a dedicated computer, an embedded processor or a processor of other programmable data processing devices so as to implement a machine such that instructions carried out by a computer or a processor of other programmable data processing devices implement an apparatus for performing functions of one or more processes/blocks in the flowcharts/block diagrams.

These computer program instructions can also be stored in a computer readable storage which can direct a computer or other programmable data processing devices to operate in a certain manner, such that the instructions stored in the computer readable storage implement an article comprising an instruction apparatus which is capable of performing functions of one or more processes/blocks in the flowcharts/block diagrams.

These computer program instructions can also be loaded into a computer or other programmable data processing devices such that a series of steps are carried out on the computer or other programmable data processing devices to generate processes to be implemented by computers. The instructions carried out on the computer or other programmable devices provide steps of performing functions of one or more processes/blocks in the flowcharts/block diagrams.

While the preferred embodiments of the present application have been described above, various modifications and alternatives to these embodiments can be made by those skilled in the art based on the fundamental inventive concept. Therefore, these preferred embodiments and all the modifications and alternatives falling within the scope of the present application are to be encompassed by the claims as attached.

Obviously, various modifications and alternatives can be made to the present application by those skilled in the art without departing from the spirit and scope of the present application. Therefore, these modifications and alternatives are to be encompassed by the present application if they fall within the scope of the claims and their equivalents.

What is claimed is:

1. An information processing method for use in an electronic device which is capable of running a first application, the method comprising:
determining, when the first application starts, whether first authentication data obtained by the electronic device at time T1 satisfies a predetermined condition, so as to obtain a first determination result, where the time T1 is prior to the starting of the first application;
presenting an application interface for the first application by using a first display strategy, if the first determination result indicates that the first authentication data obtained by the electronic device at time T1 satisfies the predetermined condition; and
presenting an application interface for the first application by using a second display strategy different from the first display strategy, if the first determination result indicates that the first authentication data obtained by the electronic device at time T1 does not satisfy the predetermined condition.

2. The method of claim 1, wherein the time T1 is a time at which the electronic device collects first authentication data for a user of the electronic device by means of a collecting unit.

3. The method of claim 1, wherein the time T1 is a time at which the electronic device switches from a screen-locked state to a screen-unlocked state.

4. The method of claim 1, wherein the time T1 is a time at which the electronic device obtains a first operation for starting the first application.

5. The method of claim 1, wherein said determining whether first authentication data obtained by the electronic device at time T1 satisfies a predetermined condition comprises:
determining whether the first authentication data obtained by the electronic device at the time T1 is null; or
determining whether the first authentication data matches preset authentication data or not, if the obtained first authentication data is not null.

6. The method of claim 5, wherein said presenting an application interface for the first application by using a first display strategy if the first determination result indicates that the first authentication data obtained by the electronic device at time T1 satisfies the predetermined condition comprises:
presenting an application interface for the first application by using a first display strategy, if the first determination result indicates that the first authentication data obtained by the electronic device at time T1 is not null and the first authentication data matches the preset authentication data.

7. The method of claim 5, wherein said presenting an application interface for the first application by using a second display strategy different from the first display strategy if the first determination result indicates that the first authentication data obtained by the electronic device at time T1 does not satisfy the predetermined condition comprises:
presenting an application interface for the first application by using a second display strategy different from the first display strategy, if the first determination result indicates that the first authentication data obtained by the electronic device at time T1 is null or if the first determination result indicates that the first authentication data obtained by the electronic device at time T1 is not null and the first authentication data does not match the preset authentication data.

8. The method of claim 1, wherein the first authentication data comprises fingerprint data, face image data, or iris data.

9. An electronic device capable of running a first application, the electronic device comprising:
a determining module configured to determine, when a first application starts, whether first authentication data obtained by the electronic device at time T1 satisfies a predetermined condition, so as to obtain a first determination result, where the time T1 is prior to the starting of the first application;
a first presenting module configured to present an application interface for the first application by using a first display strategy, if the first determination result indicates that the first authentication data obtained by the electronic device at time T1 satisfies the predetermined condition; and
a second presenting module configured to present an application interface for the first application by using a second display strategy different from the first display strategy, if the first determination result indicates that the first authentication data obtained by the electronic device at time T1 does not satisfy the predetermined condition.

10. The electronic device of claim 9, wherein the determining module is configured to:
determine whether the first authentication data obtained by the electronic device at the time T1 is null; or
determine whether the first authentication data matches preset authentication data or not, if the obtained first authentication data is not null.

11. The electronic device of claim 9, wherein the first presenting module is configured to:
present an application interface for the first application by using a first display strategy, if the first determination result indicates that the first authentication data obtained by the electronic device at time T1 is not null and the first authentication data matches the preset authentication data.

12. The electronic device of claim 9, wherein the second presenting module is configured to:
present an application interface for the first application by using a second display strategy different from the first display strategy, if the first determination result indicates that the first authentication data obtained by the electronic device at time T1 is null or if the first determination result indicates that the first authentication data obtained by the electronic device at time T1 is not null and the first authentication data does not match the preset authentication data.
